(19) United States
(12) Patent Application Publication
(10) Pub. No.: US 2005/0217434 A1
(43) Pub. Date: Oct. 6, 2005

(54) Corkscrew

(76) Inventor: Rainer Opolka, SOLINGEN (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/512,878

(22) PCT Filed: Apr. 15, 2003
(86) PCT No.: PCT/DE03/01271

§ 371 Date: Oct. 25, 2004

(30) Foreign Application Priority Data
Apr. 23, 2002 (DE) 102 17 982.4

(51) Int. Cl. B67B 7/62

(52) U.S. Cl. 81/3.37

(57) ABSTRACT

The invention relates to a corkscrew comprising a spiral (10) that is rotationally mounted inside a sleeve (28), which can be placed on the neck of a bottle, or is rotationally mounted between at least two corresponding limbs that can be placed against the neck of the bottle. The corkscrew also comprises a driving shaft (15) whose rotation actuates the spiral (10) connected thereto. In order to be able to actuate the corkscrew with a distinctly reduced expenditure of force, a reduction gear (12, 13, 14) is mounted between the driving shaft (15) and the spiral (10).

The invention relates to a cork extractor with a spiral which is disposed within a sleeve which can be seated on the edge of the bottle or rotatable between at least two corresponding limbs adapted to engage the neck of the bottle and which is actuated by a drive shaft which rotates the spiral connected therewith.

The simplest corkscrew is comprised of a spiral which, at its end not provided with the screw, has a handle secured thereto. After driving the spiral into the bottle cork to be removed, the bottle is held in one hand and the cork withdrawn by the other.

In addition, there are still other cork screws which are comprised of a handle of U-shaped cross section and, between the limbs, a screw which is hinged to the handle and is under a spring pressure and which has a support lever pivotally connected to the handle and also of U-shaped cross section. This support lever, after the driving of the screw into the cork has a noselike projection which is applied to the bottle to be opened and serves as a support for the lever as the cork is withdrawn from the bottle. Such a corkscrew may be used primarily in wine cellars or restaurant establishments and can be folded to a small size.

There are, in addition, known cork screws with a sleeve whose lower end can be seated upon the neck of the bottle and whose upper end via a screw thread is shiftable axially along the cork screw shaft.

On the same thread a nut is displaceable which, upon the driving of the spiral into the screw, enables the cork to be withdrawn with the spiral from the bottle by rotation of the nut. A variant of this type is described in German Patent DE 86 219 C and has the sleeve of the cork screw divided. On the spiral shaft, a shiftable ring is provided which, in a closed position of the sleeve by the effect of the spring tends to hold the sleeve in the closed position. When one screws the spiral into the cork, this spring is stressed and the extraction of the cork is facilitated.

All cork screws have in common that the extraction or rotation requires sufficient force to overcome the friction effect with which the cork is retained in the neck of the bottle. The cork is held in the bottle neck at a relatively high pressure which must be sufficient in the case of vibration and shock to retain the cork and the contents of the bottle firmly sealed against penetration of ambient air into the bottle. Usually the cork is sealed so tightly that a weak person cannot apply sufficient strength to remove the cork.

It is the object of the present invention to provide a cork screw or extractor which is easily handled and can enable withdrawal of a bottle cork with significantly reduced expenditure of force.

This object is achieved with the cork extractor of claim 1 characterized in accordance with the invention in that between the drive shaft and the spiral a stepdown transmission is arranged, preferably a planetary gear transmission, whose transmission ratio is between 1:2 and 1:4.

By a corresponding choice of the transmission ratio the force required for withdrawal of the cork by comparison with state of the art corkscrews can be reduced by the transmission ratio of say 1:2. This can, however, be increased further so that with actuation of the drive shaft with a finger, sufficient force may be produced. The correspondingly greater travel over which the force must be applied is easily tolerated because of the fact that the spiral receives sufficient force to enable it to drive into the cork. In practice, the great path or greater number of turns at the drive side as well as the greater cost of the structure are tolerable.

The drive shaft can be connected with a lever or cross bar to enable their actuation. In accordance with a further feature of the invention, the lever can be made telescoping or a swingable pin or arm can be provided on the lever to form a crank structure at the drive shaft.

In principle, it is also possible to connect the drive shaft with a further transmission and a vertically arranged hand crank which changes the direction of force application by 90°.

In another embodiment of the invention the step-down transmission can be provided with a locking pin or knob for enabling actuation of the transmission or for deactivating it. In this case, when the transmission is operative, the advantage of low force expenditure at the cost of a greater actuating path is obtained. When the transmission is decoupled, the shorter path but with a correspond-ingly greater force is required, depending upon what force the operating individual can or desires to use to remove the cork.

The transmission can be configured with alternatives as well and, for instance, the spiral can be connected by a member fixedly with the hollow gear of the planetary transmission or further as a unit therewith, whereby the planet gears can be spatially fixed. Alternatively, the hollow gear and the transmission housing can form a unit within which the planet gears circulate in the hollow gear.

Further embodiments of the invention are illustrated in the drawing. The drawing shows:

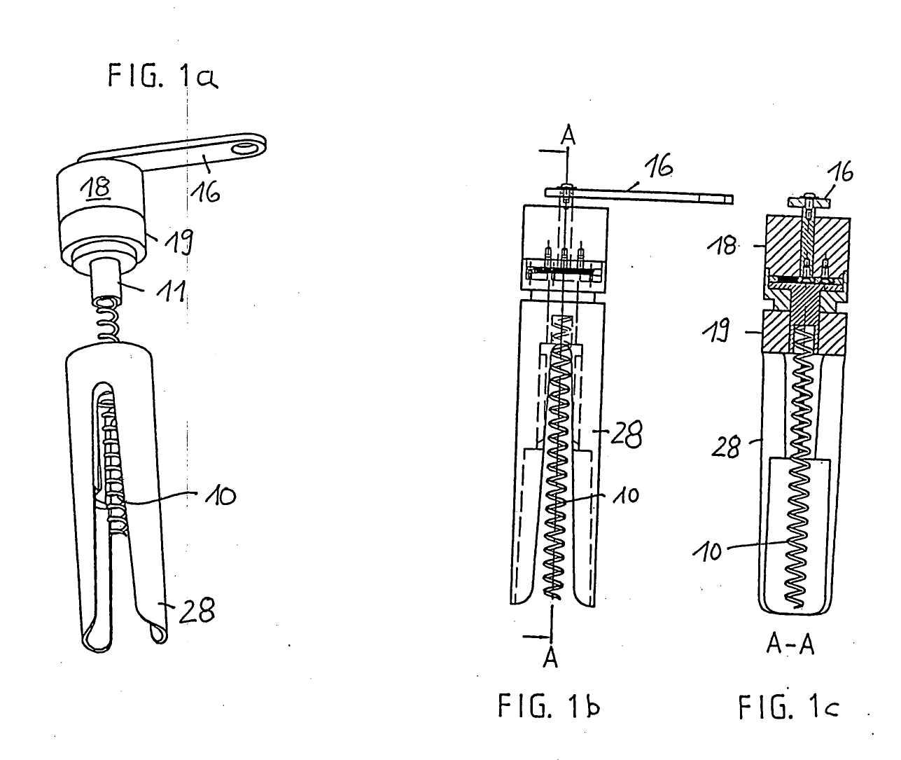

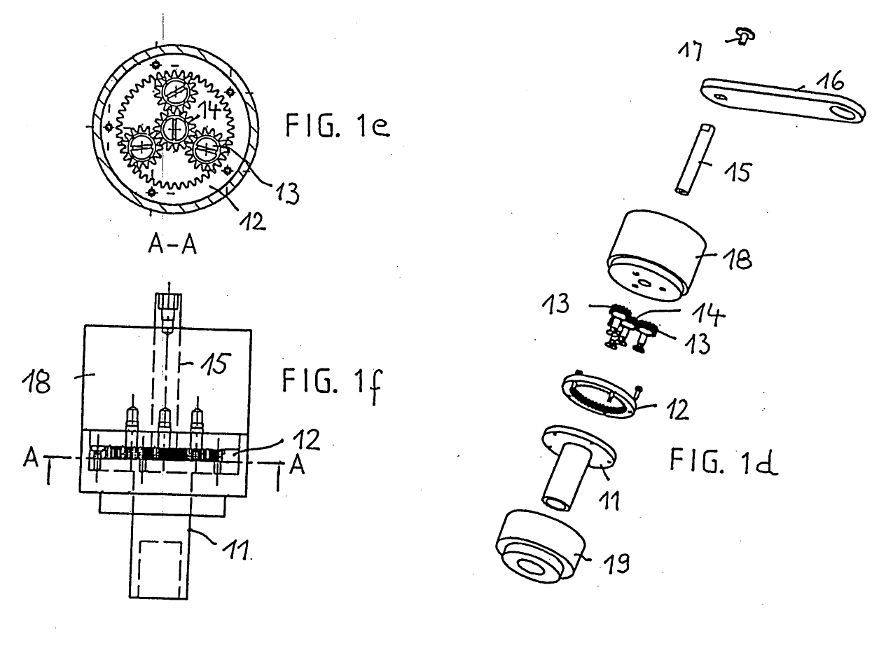

FIGS. 1a through 1c respectfully different views of a first corkscrew embodiment;

FIG. 1d an exploded view of the individual drive components;

FIG. 1e a cross section through a planetary transmission;

FIG. 1f a longitudinal section through the planetary transmission;

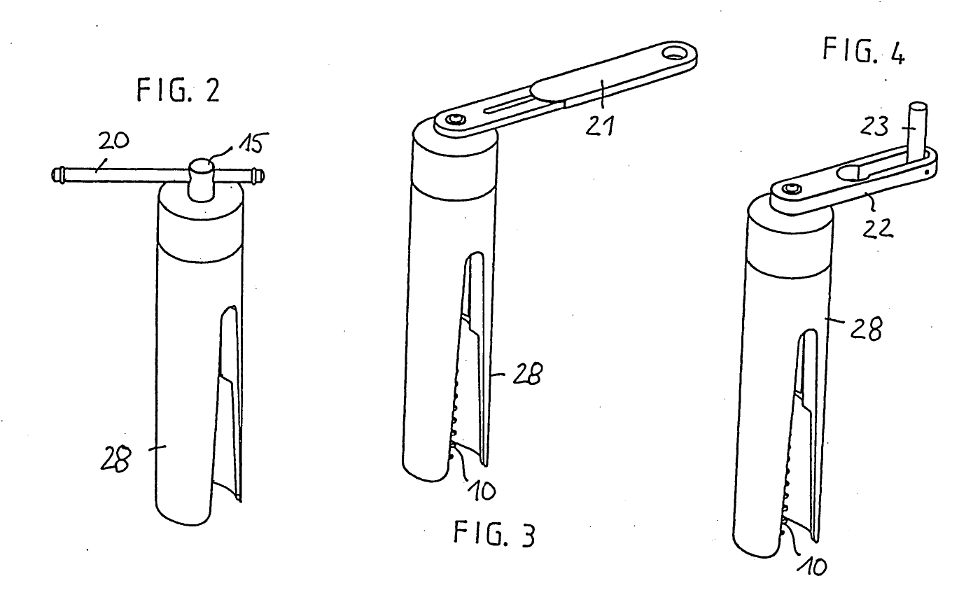

FIG. 2 a variant of a corkscrew with cross bar as the drive means;

FIG. 3 a perspective view of a corkscrew with a telescoping lever;

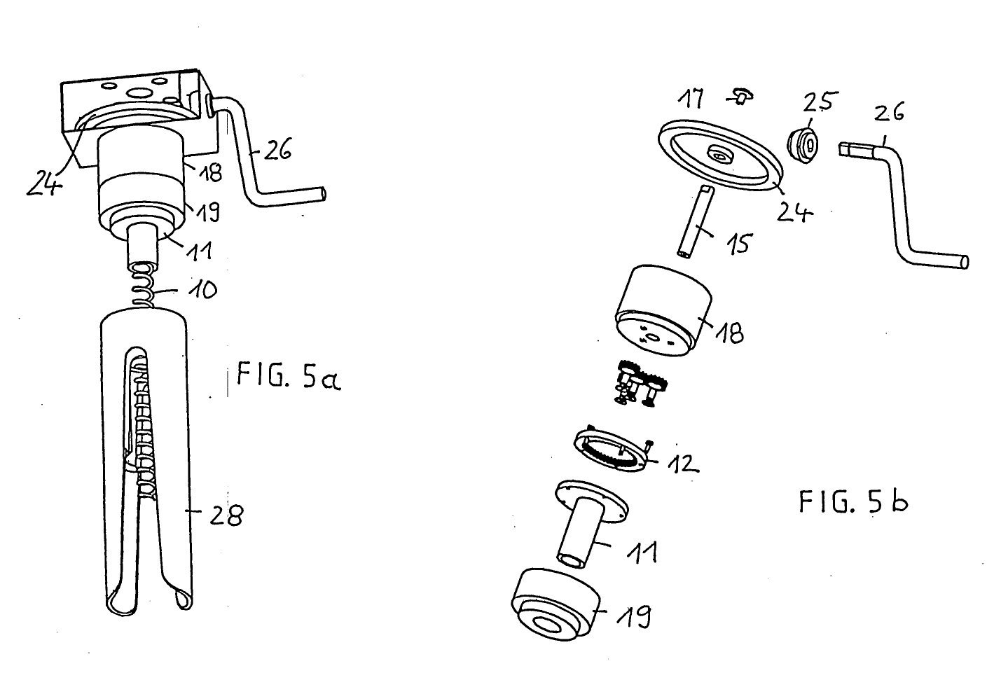

FIG. 4 a perspective view of a corkscrew with a flap and crossbar lever;

FIG. 5a a perspective view of a further embodiment of a corkscrew with a further translation connected to a crank drive;

FIG. 5b an exploded view of the drive components and connecting members associated therewith;

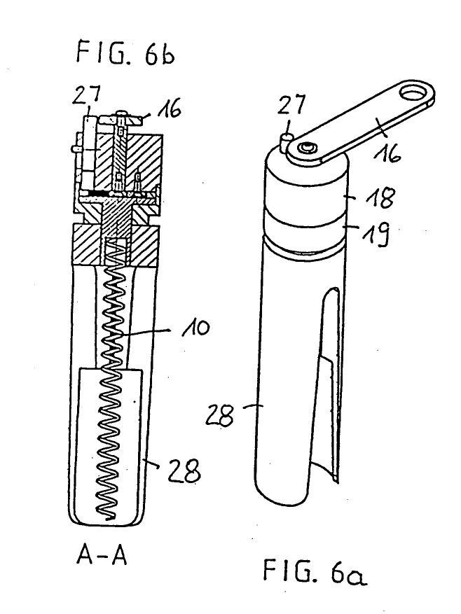

FIGS. 6a and 6b respective corkscrew embodiments with a locking knob to cut out the transmission.

Key to the corkscrew is a spiral 10 which can be driven into a cork and which has at its upper end an internally toothed hollow gear 12 fixed to the spiral via a connecting piece 11 at its upper end. This can be realized in the form of a one piece fabrication or the construction using screws as illustrated in FIG. 1d. In the hollow gear, three planet gears 13 are received as well as a central sungear [14] which is fixed to a drive shaft 15 actuated by a flat lever 16 connected to the drive shaft 15 by a rivet or screw 17. The transmission formed by the hollow gear, the planet gears and the sun gear is disposed in an upper portion 18 of a housing while the connecting piece 11 is received in a bearing bushing 19. The housing upper part 18 and the bearing bushing 19 can be, as shown in FIG. 1c, parts which are separable from one another or parts which can be connected together as is the case in the embodiment of FIG. 2. When the hollow gear and connecting part form a unit as is the case with the embodiment illustrated in FIG. 1d, the planet gears are rotatable but fixed with respect to the housing. If the hollow gear 12 and the transmission housing 18 form a unit, the planet gears 13 run around the sun gear 14. In the first mentioned case, there is a direction reversal from the drive shaft to the spiral 10 which forms the driven shaft. In the second case described, the directions of rotation are in the same sense.

Instead of the lever 16, a transverse bar 20 can be used which passes through a bore in the drive shaft 15 as shown in FIG. 2. In a further alternative, according to FIG. 3, the lever is configured as a telescoping lever 21. In accordance with a further embodiment according to FIG. 4, a swingable bar is hinged to an end of the lever 22, corresponding to the illustrations, can be swung upwardly, or recessed in the lever 22.

In accordance with a further embodiment which is somewhat more costly and has been illustrated in FIGS. 5a and 5b, the drive shaft 15 is connected with a disk 24 which has a tooth crown carried on its upper side which meshes with a pinion 25 driven and traversed by a hand crank 26. Otherwise reference may be had to the construction shown in FIG. 1d.

As can be seen from FIGS. 6a and 6b, the corkscrew can be driven by means of a transmission that can be coupled to the lever or disengaged therefrom by means of a locking knob or pin 27. In the decoupled state of the transmission, the drive shaft 15 and the spiral 11 are directly connected together so that the transmission ratio is 1:1. When the transmission is in play, depending upon the transmission construction, a different transmission ratio can be selected which enables the force for withdrawing the cork to be significantly reduced.

1. A cork extractor comprising a spiral which is disposed within a sleeve adapted to be seated on the edge of a bottle or which is rotatable between at least two corresponding limbs adapted to engage the neck of a bottle and which is actuated by a drive shaft whose rotation can actuate the spiral connected therewith, and a reducing transmission between the drive shaft and the spiral.

2. The cork extractor according to claim 1 wherein the transmission is a planetary transmission, preferably with a transmission ratio of 1:2 to 1:4.

3. The cork extractor according to claim 2 wherein the drive shaft is connected with a lever or a crossbar.

4. The cork extractor according to claim 3, wherein the lever is telescopingly elongatable and/or has a cross bar which can be swung up and taken.

5. The cork extractor according to claim 2 wherein the drive shaft is connected by a further transmission with a hand crank.

6. The cork extractor according to claim 2 wherein by means of a locking pin (27) the reducing transmission (12 to 14) can be engaged and disengaged.

7. The cork extractor according to the spiral is connected by a connecting member fixedly with a hollow gear of the planetary transmission or forms a unit therewith and wherein the planet gears are fixed in position.

8. The cork extractor according to a hollow gear of the planetary gear transmission and the transmission housing form a unit and the planet gears are movable to circulate in the transmission housing.
